(19) United States
(12) Patent Application Publication
(10) Pub. No.: US 2015/0215112 A1
(43) Pub. Date: Jul. 30, 2015

(54) USER TERMINAL DEVICE AND SECURED COMMUNICATION METHOD THEREOF

(71) Applicant: SAMSUNG ELECTRONICS CO., LTD., Suwon-si (KR)

(72) Inventor: Han-gil MOON, Daejeon (KR)

(73) Assignee: SAMSUNG ELECTRONICS CO., LTD., Suwon-si (KR)

(21) Appl. No.: 14/608,642

(22) Filed: Jan. 29, 2015

(30) Foreign Application Priority Data
Jan. 29, 2014 (KR) 10-2014-0011479
Oct. 14, 2014 (KR) 10-2014-0138570

(51) Int. Cl. H04L 9/06

(52) U.S. Cl. CPC H04L 9/065; H04L 2209/601

(57) ABSTRACT

Provided are a user terminal device and a secured communication method thereof. The secured communication method includes: encrypting a voice bitstream including voice data corresponding to a user voice for a call in a security mode between the user terminal device and another user terminal device; inserting the encrypted voice bitstream into a video transmission stream; and transmitting the video transmission stream, into which the encrypted voice bitstream is inserted, to the other user terminal device.

### CROSS-REFERENCE TO RELATED APPLICATIONS

This application claims priority from Korean Patent Application No. 10-2014-0011479, filed on Jan. 29, 2014, and Korean Patent Application No. 10-2014-0138570, filed on Oct. 14, 2014, in the Korean Intellectual Property Office, the disclosures of which are incorporated herein by reference in their entireties.

### BACKGROUND

1. Field

Aspects of exemplary embodiments relate to a user terminal device and a secured communication method thereof, and more particularly, to a user terminal device that performs a secured communication for voice data by using a video transmission stream and a secured communication method thereof.

2. Description of the Related Art

The widespread distribution of smartphones has brought about a sudden increase in users of Wide-band Code Division Multiple Access (WCDMA) 3G and Long Term Evolution (LTE) 4G mobile communications. Using these communications, users are frequently concerned with security and privacy. In particular, there are growing concerns due to social issues such as communication tapping (e.g., wiretapping) or monitoring, and demands of users for safe communications have increased. Therefore, a secured communication-related market has greatly grown in public sectors and private sectors.

According to a related art technology, when a secured communication for voice data is performed, the voice data is encrypted by using a vocoder installed in a modem or by a protocol end that forms a transmission packet.

If the voice data is encrypted by using the vocoder of the modem, the modem may include a vocoder that supports a secured communication for the voice data. However, if the modem does not include the vocoder that supports the secured communication for the voice data, the vocoder must be updated in the modem. In this case, if a modem supply company does not provide a development environment for updating the modem, a secured communication environment may not be provided.

Also, if the protocol terminal that forms the transmission packet encrypts the voice data, and a system is changed (e.g., if a network business operator is changed or a communication is changed between 3G and 4G), it is difficult for the changed system to recognize an encrypted packet. Therefore, it is difficult to maintain the secured communication.

### SUMMARY

Exemplary embodiments address at least the above problems and/or disadvantages and other disadvantages not described above. Also, exemplary embodiments are not required to overcome the disadvantages described above, and an exemplary embodiment may not overcome any of the problems described above.

Aspects of one or more exemplary embodiments provide a user terminal device that inserts an encrypted voice bitstream into a video transmission stream and transmits the video transmission stream with the encrypted voice bitstream to perform a secured communication, and a secured communication method thereof.

According to an aspect of an exemplary embodiment, there is provided a method of performing a secured communication by a user terminal device, the method including: encrypting a first voice bitstream including voice data corresponding to a user voice for a call in a security mode between the user terminal device and another user terminal device; inserting the encrypted first voice bitstream into a first video transmission stream; and transmitting the first video transmission stream, into which the encrypted first voice bitstream is inserted, to the other user terminal device.

The encrypting the first voice bitstream may include: encoding the voice data corresponding to the user voice to generate the first voice bitstream; encrypting at least a portion of data of the first voice bitstream; and inserting, into the first voice bitstream, encryption information used for the encrypting.

The first voice bitstream may include: a header area including information indicating that the voice data is included in the first voice bitstream; and a payload area including the encoded voice data.

The encrypting the at least the portion of the data may include encrypting the payload area of the first voice bitstream.

The first voice bitstream may further include an auxiliary area, and the encryption information may be inserted into at least one of the header area, the payload area, and the auxiliary area of the first voice bitstream.

The encryption information may include at least one of an encryption key, a position of an encrypted area of the first voice bitstream, and an encryption algorithm type.

The method may further include: generating a voice transmission stream including silent data; and transmitting the generated voice transmission stream to the other user terminal device.

The method may further include: generating a voice transmission stream including encryption information used for the encrypting; and transmitting the generated voice transmission stream to the other user terminal device.

The method may further include in response to receiving a second video transmission stream into which an encrypted second voice bitstream is inserted when performing a call in the security mode, processing the received second video transmission stream by using a security mode vocoder.

The processing the received second video transmission stream may include: extracting the encrypted second voice bitstream from the received second video transmission stream; obtaining, from the extracted second voice bitstream, encryption information for decrypting the encrypted second voice bitstream; decrypting the encrypted second voice bitstream based on the obtained encryption information; and decoding the decrypted second voice bitstream to output voice data.

The method may further include, in response to the call being performed in the security mode, turning off a camera module and a video call output unit of the user terminal device, and outputting the voice data of the received second video transmission stream using a normal call output unit.

For the call in the security mode, the voice data may be processed by using an application processor distinct from a communication modem of the user terminal device for processing voice data for a call in a normal mode.

According to an aspect of another exemplary embodiment, there is provided a user terminal device including: a security module configured to encrypt a first voice bitstream including voice data corresponding to a user voice for a call in a security mode between the user terminal device and another user terminal device, and to insert the encrypted first voice bitstream into a first video transmission stream; and a communication module configured to transmit the first video transmission stream, into which the encrypted first voice bitstream is inserted, to the other user terminal device.

The security module may include: an encoder configured to encode the voice data corresponding to the user voice to generate the first voice bitstream; an encryptor configured to encrypt at least a portion of data of the first voice bitstream; and an encryption information inserter configured to insert, into the first voice bitstream, encryption information used for the encrypting.

The first voice bitstream may include: a header area including information indicating that the voice data is included in the first voice bitstream; and a payload area including the encoded voice data.

The encryptor may be configured to encrypt the payload area of the first voice bitstream.

The first voice bitstream may further include an auxiliary area; and the encryption information inserter may be configured to insert the encryption information into at least one of the header area, the payload area, and the auxiliary area of the first voice bitstream.

The encryption information may include at least one of an encryption key, a position of an encrypted area of the first voice bitstream, and an encryption algorithm type.

The security module may further include a silent data generator configured to generate a voice transmission stream including silent data; and the communication module may be configured to transmit the generated voice transmission stream to the other user terminal device.

The communication module may be configured to transmit, to the other user terminal device, a voice transmission stream including encryption information used for the encrypting.

In response to receiving a second video transmission stream into which an encrypted second voice bitstream is inserted when performing a call in the security mode, the security module may be configured to process the received second video transmission stream by using a security mode vocoder.

The user terminal device may further include: an output module, wherein the security module may further include: an extractor configured to extract the encrypted second voice bitstream from the received second video transmission stream; an encryption information acquirer configured to obtain encryption information for decrypting the encrypted second voice bitstream; and a deciphering unit configured to decrypt the encrypted second voice bitstream based on the obtained encryption information, and wherein the output module may be configured to decode the decrypted second voice bitstream to output voice data.

The user terminal device may further include: a camera module configured to, in response to a video call being performed, capture an image of a user, wherein the output module includes a video call output unit and a normal call output unit, and wherein in response to the call being performed in the security mode, the user terminal device turns off the camera module and the video call output unit and outputs the voice data of the received second video transmission stream by using the normal call output unit.

According to an aspect of another exemplary embodiment, there is provided a method of performing a secured communication of a user terminal device, the method including: receiving, through a first voice transmission stream, an encrypted first voice bitstream from an external user terminal device; determining whether it is possible to recognize the encrypted first voice bitstream received from the external user terminal device; in response to the encrypted first voice bitstream being recognizable according to the determining, making a call to the external user terminal in a first security mode in which an encrypted second voice bitstream is transmitted through a second voice transmission stream; and in response to the encrypted first voice bitstream being unrecognizable according to the determining, making a call to the external user terminal device in a second security mode in which the encrypted second voice bitstream is transmitted through a video transmission stream.

The making the call in the second security mode may include: in response to the encrypted first voice bitstream being unrecognizable according to the determining, outputting a user interface (UI) for making the call in the second security mode; and in response to a user command being input through the output UI, making the call to the external user terminal device in the second security mode.

The making the call in the second security mode may include turning on a voice capturing function and turning off a video capturing function.

The making the call in the second security mode may include: encrypting the second voice bitstream corresponding to an input user voice; changing a port for outputting the encrypted second voice bitstream to a video port; inserting the encrypted second voice bitstream into the video transmission stream; and transmitting the video transmission stream to the external user terminal device.

The making the call in the second security mode may further include: inserting at least one of a null packet and encryption information into a third voice transmission stream; and transmitting the third voice transmission stream to the external user terminal device.

The transmitting of the video transmission stream may be delayed relative to the third voice transmission stream by a preset time.

The inserting may include inserting, as the encryption information, information indicating that the second voice bitstream is encrypted.

The inserting may include inserting, as the encryption information, at least one of an encryption key, a position of an encrypted area of the second voice bitstream, and an encryption algorithm type.

According to an aspect of another exemplary embodiment, there is provided a user terminal including: a communication module configured to receive, through a first voice transmission stream, an encrypted first voice bitstream from an external user terminal device; and a control module configured to determine whether it is possible to recognize the encrypted first voice bitstream, to make, in response to the encrypted first voice bitstream being recognizable according to the determining, a call to the external user terminal device in a first security mode in which an encrypted second voice bitstream is transmitted through a second voice transmission stream, and to make, in response to the encrypted voice bitstream being unrecognizable according to the determining, a call to the external user terminal device in a second security mode in which the encrypted second voice bitstream is transmitted through a video transmission stream.

The user terminal device may further include a mode setting module, wherein the control module may be configured to control the mode setting module to output a UI for making the call in the second security mode in response to the encrypted first voice bitstream being unrecognizable according to the determining, and to make the call to the external user terminal in the second security mode in response to a user command being input through the output UI.

In response to the call being made in the second security mode, the control module may be configured to turn on a voice capturing function and to turn off a video capturing function.

The user terminal device may further include: a security module configured to, in response to the call being made to the external user terminal device in the second security mode, encrypt the second voice bitstream corresponding to an input user voice, to change a port for outputting the encrypted second voice bitstream to a video port, and to insert the encrypted second voice bitstream into the video transmission stream, wherein the communication module may be configured to transmit the video transmission stream to the external user terminal.

The security module may be configured to insert at least one of a null packet and encryption information into a third voice transmission stream; and the communication module may be configured to transmit the third voice transmission stream to the external user terminal device.

The communication module may be configured to delay the transmitting of the video transmission stream relative to the third voice transmission stream for a preset time.

The security module may be configured to insert, as the encryption information, information indicating that the second voice bitstream is encrypted.

The security module may be configured to insert, as the encryption information, at least one of an encryption key, a position of an encrypted area of the second voice bitstream, and an encryption algorithm type.

According to an aspect of another exemplary embodiment, there is provided a method of performing a secured communication by a user terminal device, the method including: receiving a video transmission stream including an encrypted voice bitstream when performing a voice call in a security mode; and in response to the receiving the video transmission stream, processing the received video transmission stream to output voice data.

The method may further include receiving a voice transmission stream distinct from the video transmission stream when performing the call in the security mode.

The voice transmission stream may include at least one of silent data and encryption information.

The voice transmission stream may include, as the encryption information, information indicating that the voice bitstream is encrypted.

The voice transmission stream may include, as the encryption information, at least one of an encryption key, a position of an encrypted area of the voice bitstream, and an encryption algorithm type.

The processing the received video transmission stream may include inputting the received video transmission stream to a vocoder for voice processing, as opposed to a video processor of the user terminal device used to process video transmission streams for video calls.

The processing the received second video transmission stream may include: extracting the encrypted voice bitstream from the received video transmission stream; obtaining encryption information for decrypting the encrypted second voice bitstream; decrypting the encrypted voice bitstream based on the obtained encryption information; and decoding the decrypted voice bitstream to output the voice data.

The obtaining may include obtaining the encryption information from the extracted voice bitstream.

The obtaining may include obtaining the encryption information from a voice transmission stream distinct from the video transmission stream.

The method may further include, when performing the voice call in the security mode, turning off a camera module and a video call output unit of the user terminal device, and outputting the voice data of the received video transmission stream using a normal call output unit.

The method may further include receiving a voice transmission stream including an unencrypted voice bitstream when performing a call in a normal mode.

The method may further include receiving a voice transmission stream including an encrypted voice bitstream when performing a call in another security mode.

According to an aspect of another exemplary embodiment, there is provided a non-transitory computer readable recording medium having recorded thereon a program executable by a computer for performing any of the above methods.

### BRIEF DESCRIPTION OF THE DRAWINGS

The above and/or other aspects will be more apparent by describing certain exemplary embodiments with reference to the accompanying drawings, in which:

FIG. 1 is a view illustrating a secured communication method according to an exemplary embodiment;

FIG. 2 is a block diagram illustrating a structure of a user terminal device according to an exemplary embodiment;

FIG. 3 is a block diagram illustrating a structure of a security module of FIG. 2, according to an exemplary embodiment;

FIG. 4 is a view illustrating a voice bitstream according to an exemplary embodiment;

FIG. 5 is a block diagram illustrating a structure of a stream generator of FIG. 3, according to an exemplary embodiment;

FIGS. 6A through 6C are views illustrating an output module of FIG. 2, according to an exemplary embodiment;

FIG. 7 is a flowchart illustrating a secured communication method of a user terminal device of a transmitter, according to an exemplary embodiment;

FIG. 8 is a flowchart illustrating a method of encrypting a voice bitstream, according to an exemplary embodiment;

FIG. 9 is a flowchart illustrating a secured communication method of a user terminal device of a receiver, according to an exemplary embodiment;

FIG. 10 is a sequence diagram illustrating a secured communication method according to an exemplary embodiment;

FIG. 11 is a flowchart illustrating a secured communication method of a user terminal device, according to another exemplary embodiment;

FIG. 12 is a flowchart illustrating a method of performing a secured communication in a second security mode, according to another exemplary embodiment;

FIG. 13 is a view illustrating a user interface (UI) for setting a secured communication performed in a second security mode, according to an exemplary embodiment;

FIGS. 14A and 14B, 15A and 15B, and 16A and 16B are views illustrating a method of transmitting a voice transmission stream and a video transmission stream according to an exemplary embodiment;

FIGS. 17A and 17B are views illustrating data that is inserted into a voice transmission stream and a video transmission stream in a normal call and data that is inserted into a voice transmission stream and a video transmission stream when performing a secured call in a second security mode, according to an exemplary embodiment; and

FIGS. 18A and 18B are views illustrating data that is inserted into a voice transmission stream and a video transmission stream, according to another exemplary embodiment.

### DETAILED DESCRIPTION OF EXEMPLARY EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of exemplary embodiments. Thus, it is apparent that exemplary embodiments can be carried out without those specifically defined matters. Also, well-known functions or constructions are not described in detail since they would obscure exemplary embodiments with unnecessary detail.

Although the terms first, second, etc., may be used herein to describe various elements, these elements should not be limited by these terms. These terms are only used to distinguish one element from another element.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

In exemplary embodiments, a “module” or a “unit” may perform at least one function or operation and may be embodied as hardware or software or as a combination of hardware and software. Also, a plurality of “modules” or a plurality of “units” may be integrated into at least one module except a “module” or a “unit” that may be embodied as particular hardware, to be embodied as at least one processor.

According to exemplary embodiments, a user terminal device may be referred to as a mobile or stationary user terminal device such as user equipment (UE), a mobile station (MS), an advanced mobile station (AMS), a device, or the like.

Hereinafter, exemplary embodiments will be described in detail with reference to the attached drawings. Like reference numerals in the drawings denote like elements.

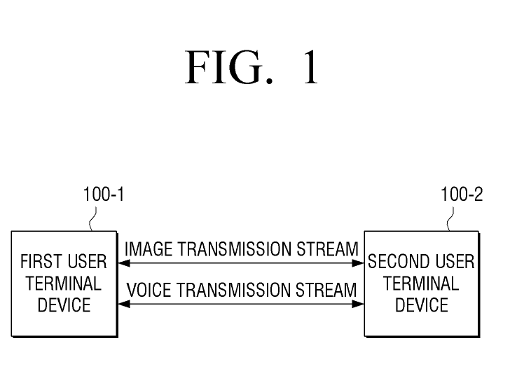

FIG. 1 is a view illustrating a secured communication method of a secured communication system according to an exemplary embodiment. Referring to FIG. 1, the secured communication system includes a first user terminal device 100-1 and a second user terminal device 100-2.

When performing a normal video call, the first user terminal device 100-1 processes voice data by using a communication modem (e.g., a Long Term Evolution (LTE) modem, a Code Division Multiple Access (CDMA) modem, or a Wideband Code Division Multiple Access (WCDMA) modem) included in a communication processor to generate a voice transmission stream and transmits the generated voice transmission stream to the second user terminal device 100-2. The first user terminal device 100-1 also processes video data by using an application processor to generate a video transmission stream and transmits the generated video transmission stream to the second user terminal device 100-2.

In particular, the first user terminal device 100-1 and the second user terminal device 100-2 may perform a voice call in a secured communication mode (hereinafter referred to as a security mode) by using a flow (e.g., operational flow) of the video call as described above. That is, in the second communication mode, a voice call may be performed by at least one of processing the voice data by the application processor for generating the video transmission stream, transmitting the voice data in the video transmission stream, and outputting the voice data via a port for outputting the video transmission stream (i.e., as opposed to a port for outputting a voice transmission stream). In detail, if the security mode is set between the first user terminal device 100-1 that is a transmitter and the second user terminal device 100-2 that is a receiver, the first user terminal device 100-1 generates and encrypts a voice bitstream including voice data, inserts the encrypted voice bitstream into the video transmission stream, and transmits the video transmission stream, into which the encrypted voice bitstream is inserted, to the second user terminal device 100-2 through a communication channel. Furthermore, the first user terminal device 100-1 generates a voice transmission stream including silent data (e.g., null data) and transmits the voice transmission stream to the second user terminal device 100-2 through the communication channel. According to another exemplary embodiment, the first user terminal device 100-1 may generate the voice transmission stream including at least one of the silent data, information indicating the security mode (e.g., encryption information or an encryption flag indicating that the voice bitstream is included in the video transmission stream and/or indicating that an encrypted voice bitstream is included), and encryption information (e.g., an encryption key) for encrypting or decrypting the voice bitstream. Additionally, according to another exemplary embodiment, transmission of the video transmission stream may be delayed relative to the transmission of the voice transmission stream.

The second user terminal device 100-2 may extract the encrypted voice bitstream from the video transmission stream and process the encrypted voice bitstream to provide the voice data to a user of the second user terminal device 100-2. If the first user terminal device 100-1 performs a call in the security mode, the second user terminal device 100-2 may input the video transmission stream into a structure for voice processing (e.g., a vocoder), as opposed to a structure for video processing to process the video transmission stream. The second user terminal device 100-2 may also bypass (e.g., discard, mute, or ignore) the voice transmission stream including the silent data.

In the security mode, another programmable processor (e.g., an application processor, a digital signal processor, or the like), as opposed to the communication modem or a communication processor of the communication modem, may perform decoding to achieve a secure voice communication.

According to an exemplary embodiment, when a call is performed in the security mode, a voice bitstream is inserted into a video transmission stream. Therefore, encrypted voice data may be transmitted and received without changing or updating a communication modem, and encryption information may be prevented from being lost due to transcoding in various communication environments. Also, a secured communication for voice data may be provided between user terminal devices without updating a communication system.

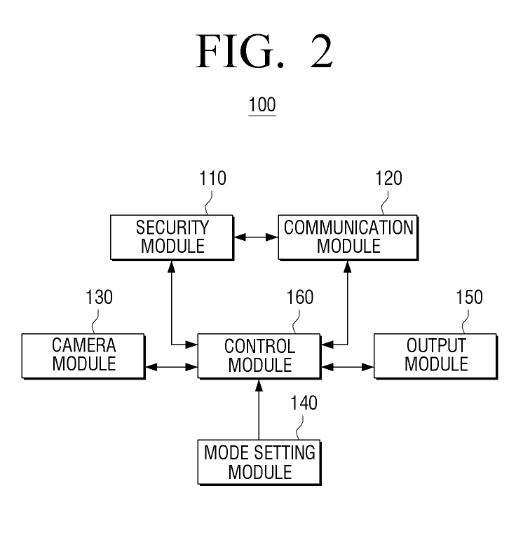

A user terminal device 100 according to an exemplary embodiment will now be described in more detail with reference to FIGS. 2 through 5 and 6A through 6C. Referring to FIG. 2, the user terminal device 100 includes a security module 110, a communication module 120, a camera module 130, a mode setting module 140, an output module 150, and a control module 160.

FIG. 2 illustrates the user terminal device 100 having various functions (i.e., operations) such as a video call function, a security communication function, etc., as exemplarily embodied by various types of elements in the figure. It is understood that, according to one or more other exemplary embodiments, some of the elements of FIG. 2 may be omitted or changed or other types of elements may be further added.

In a security mode, the security module 110 may encrypt at least a portion of data constituting a voice bitstream corresponding to a user voice and insert information related to encrypting into the voice bitstream, to generate an encrypted voice bitstream. The security module 110 may also insert the encrypted voice bitstream into a video transmission stream and transmit the encrypted voice bitstream inserted into the video transmission stream to an external user terminal device or a server through the communication module 120. In detail, the security module 110 may encrypt voice data included in at least one of a payload area and a header area of the voice bitstream and insert encryption information into an auxiliary area. Here, the security module 110 may insert the encryption information into the auxiliary area, though it is understood that one or more other exemplary embodiments are not limited thereto. That is, in various exemplary embodiments, the security module 110 may insert the encryption information into at least one of the payload area, the header area, and the auxiliary area. The encryption information may include at least one of an encryption key, a position of an encrypted area, and an encryption algorithm type. The encryption key may be key data, an index of the key data, or a pointer value of the key data. If the encryption key is divided and inserted into a bitstream, division information may be included.

In the security mode, the security module 110 may generate silent data and generate a voice transmission stream by using the generated silent data. The security module 110 may provide the generated voice transmission stream to the communication module 120.

If a video transmission stream received through the communication module 120 includes the encrypted voice bitstream, the security module 110 may extract the encrypted voice bitstream from the video transmission stream and acquire encryption information from the encrypted voice bitstream to decipher or decrypt the encrypted voice bitstream. Here, the security module 110 may insert the video transmission stream into a security mode vocoder for voice processing, as opposed to a structure for video processing to process the video transmission stream.

In a normal mode, the security module 110 may generate a voice bitstream by using input voice data without encrypting an input signal and provide the generated voice bitstream to the communication module 120. If a packet received through the communication module 120 does not include the encrypted voice bitstream, the security module 110 may decode an original signal from the bitstream without deciphering or decrypting the bitstream.

The security module 110 may generate the voice bitstream by using a codec algorithm that is installed in the user terminal device 100, stored in hardware removable from the user terminal device 100, or downloaded from a network. The security module 110 may perform encrypting or deciphering by using an encryption algorithm that is installed in the user terminal device 100, stored in hardware removable from the user terminal device 100, or downloaded from a network. Here, the encryption algorithm may include substitutions of data or various operations by using an encryption key.

The communication module 120 may include at least one antenna or communication terminal, generate a packet corresponding to a preset communication protocol by using the video transmission stream or the voice transmission stream provided from the security module 110, and transmit the packet through a communication channel that is wired or wireless. The communication module 120 may parse the video transmission stream or the voice transmission stream from a packet received by wired or wireless communication and provide the video transmission stream and the voice transmission stream to the security module 110.

Here, the communication channel may be a 2G network, a 3G network, a 4G network, a Beyond 4G (B4G) network, a 5G network, a Wi-Fi network, an Internet Protocol (IP) network, a direct communication network between terminal devices, another next generation network, or a heterogeneous network, etc. The communication channel may be referred to as a voice network, a data network, a circuit switching network, a packet switching network, or an IP Multimedia Subsystem (IMS) network.

When a video call is performed, the camera module 130 is turned on to capture an image of a user. However, if a voice communication is performed in the security mode by using a flow (e.g., operational flow) of the video call, power supplied to the camera module 130 is disconnected to not allow the camera module 130 to capture an image of the user.

The mode setting module 140 may set an operation mode related to a secured communication. The mode setting module 140 may include at least one button that is installed or included in a user interface (UI), a graphic user interface (GUI), or a terminal device. The operation mode may include at least one of a security mode setting, an encryption strength, and a secured communication object, though it is understood that one or more other exemplary embodiments are not limited thereto. However, if there is no need for a user input in relation to the secured communication, the mode setting module 140 may not be included in the user terminal device 100.

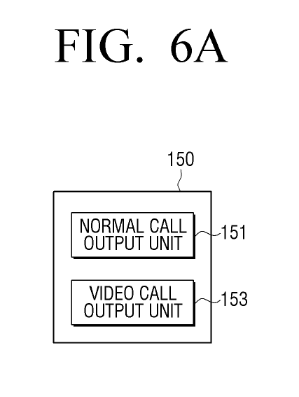

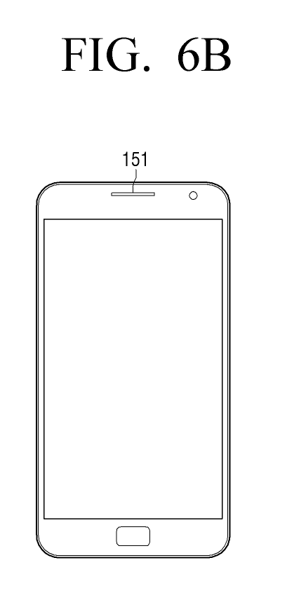

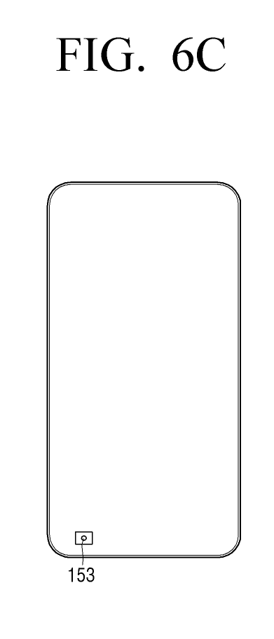

The output module 150 outputs a user voice. Here, as shown in FIG. 6A, the output mode 150 may include a normal call output unit 151 (e.g., a normal call outputter) and a video call output unit 153 (e.g., a video call outputter). Here, if the user terminal device 100 is a smartphone, the normal call output unit 151 may be a speaker that is installed or provided in a front surface of the smartphone as shown in FIG. 6B to be positioned on an ear of the user and to output voice data when performing a phone call. The video call output unit 153 may be a speaker that is installed or provided in a back surface of the smartphone as shown in FIG. 6C to output voice data when performing a video call. Here, the video call output unit 153 that is installed or provided in the back surface of the smartphone is only an exemplary embodiment, and it is understood that one or more other exemplary embodiments are not limited thereto. For example, the video call output unit 153 may be installed or located in an area of any corner or edge of the smartphone.

If a normal video call is performed, the output module 150 may output voice data through the video call output unit 153. However, if a call is performed in the security mode by using a flow of a video call, the output module 150 output voice data through the normal call output unit 151. In this case, the output module 150 may disconnect power to the video call output unit 153.

The control module 160 (e.g., controller) may control an overall operation of the user terminal device 100. The control module 160 may control elements of the user terminal device 100 to operate in a mode set by the user or may control the elements of the user terminal device 100 to operate in a preset mode.

The control module 160 may determine whether a communication in a security mode is possible through a user terminal device of a receiver. In detail, the control module 160 may acquire information of the user terminal device of the receiver in a communication connection process to determine whether the communication in the security mode is possible through the user terminal device of the receiver.

The security mode may be set by inquiring from the user whether to set the security mode before or after the receiver is called. According to an exemplary embodiment, the setting of the security mode may include setting of a secured communication starting and/or ending time. The secured communication starting or ending time may be equal to a call starting or ending time or may be set when performing a call. The security mode that is primarily set may be automatically released or reset according to a network situation.

The encryption strength may be variably set according to receivers or groups of receivers or according to the network situation and may include a single encryption mode, a double encryption mode, and a triple encryption mode. If a terminal device includes a plurality of encryption algorithms or a plurality of key generating methods, the encryption strength may be variably set according to encryption algorithms or key generating methods. A length of the encryption key may be adjusted to variably set the encryption strength.

The secured communication object may request the user to check a setting of the security mode according to receiver or the security mode may be automatically set for an additionally designated receiver group. Alternatively, the security mode may be automatically set for a receiver that has performed a secured communication or the user may be re-requested to check the setting of the security mode. Here, settings of the encryption strength and the secured communication object may be related or linked to each other. For example, an encryption key corresponding to a higher encryption strength may be allocated to a special receiver or receiver group.

According to an exemplary embodiment, a motion, a gesture, or a voice of the user may be recognized to set the security mode. Examples of the motion of the user may include particular activities on a terminal device such as a multi-tap input on the terminal device, rubbing on a particular part of the terminal device, etc. Examples of the gesture of the user may include a particular motion of the user performed while holding the terminal device, etc. According to another exemplary embodiment, bio-information including instruction contents of the user related to the security mode may be recognized to set the security mode. For example, the bio-information may be recognized through a Brain-Computer Interface (BCI) or a Brain-Machine Interface (BMI). Contents and recognition activities of the security mode may be mapped to each other and pre-stored in the terminal device.

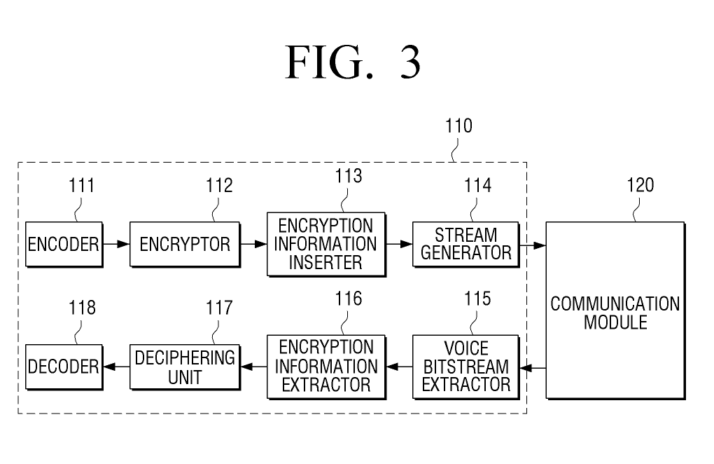

FIG. 3 is a block diagram illustrating a structure of a security module 110, according to an exemplary embodiment. Referring to FIG. 3, the security module 110 includes an encoder 111, an encryptor 112, an encryption information inserter 113, a stream generator 114, a voice bitstream extractor 115, an encryption information extractor 116, a deciphering unit 117 (e.g., decryptor), and a decoder 118.

The encoder 111 encodes input voice data by using a preset algorithm to generate a voice bitstream. Here, a codec algorithm may include various types of codec algorithms such as a standard codec algorithm (e.g., Moving Picture Experts Group (MPEG) audio or the like proposed by the International Organization for Standardization (ISO)/International Electrotechnical Commission (IEC)), a G series of standard codec algorithm such as G.722 or the like, an independent or proprietary codec algorithm, etc. The voice bitstream may include a parameter used for encoding and encoded data, and a detailed format thereof may vary according to the codec algorithm.

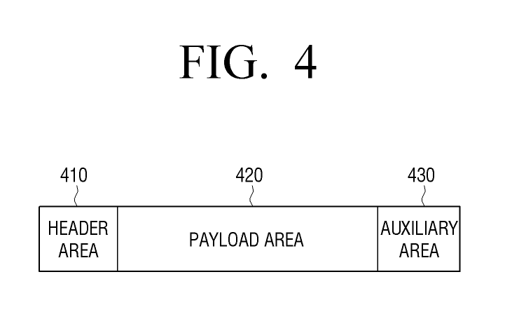

As shown in FIG. 4, the voice bitstream may include a header area 410, a payload area 420, and an auxiliary area 430. Here, an area corresponding to the auxiliary area 430 may be allocated into particular positions of the header area 410 and the payload area 420. The header area 410 may include information related to the payload area 420 (e.g., information indicating whether data included in the payload area 420 is voice data, information indicating a codec algorithm type, or the like). The payload area 420 may include a field in which encoded voice data and a parameter for decoding the encoded voice data are arranged, and the auxiliary area 430 may include a reserved field for future use. An auxiliary area arranged in a particular position of the header area 410 or the payload area 420 may also include a reserved field for future use. An arrangement order of each of the header area 410, the payload area 420, and the auxiliary area 430 may be limited or may not be limited. Also, a plurality of header areas, a plurality of payload areas, and a plurality of auxiliary areas may be included and another area may be added into a voice bitstream or a structure of the voice bitstream may be changed according to an updated version of the codec algorithm.

The encryptor 112 encrypts at least a portion of data of the voice bitstream generated or encoded by the encoder 111. At least a portion of data included in a header area 410 or a payload area 420 of the voice bitstream may be encrypted or at least a portion of data of the header area and the payload area may be encrypted together. According to another exemplary embodiment, at least a portion of data included in an auxiliary area may be encrypted.

The encryptor 112 may also generate or provide an encryption key for encrypting. Here, the encryption key may include a basic key and a reinforcement key. The basic key may be a symmetric key, an asymmetric key, or a mixed key, and the reinforcement key may be a key that encrypts the basic key, a key that re-encrypts an area encrypted by the basic key, or a key that enables deciphering or decrypting in a user terminal device of a particular receiver.

A key-based encryption algorithm may be used for encrypting. Examples of the encryption algorithm may include an algorithm using a symmetric key or a private key, an algorithm using an asymmetric key or a public key, an algorithm mixing and using a symmetric key and an asymmetric key, and a quantum encryption algorithm, though it is understood that one or more other exemplary embodiments are not limited thereto. The algorithm using the symmetric key or the asymmetric key may use a stream encryption key such as Rivest Cipher 4 (RC4) or a block encryption key such as Rivest Cipher 5 (RC5), International Data Encryption Algorithm (IDEA), Data Encryption Standard (DES), Advanced Encryption Standard (AES), ARIA, SEED, Triple DES (3DES), or the like, though it is understood that one or more other exemplary embodiments are not limited thereto. The algorithm using the asymmetric key or the public key may use a Rivest, Shamir, Adleman (RSA) public key, though it is understood that one or more other exemplary embodiments are not limited thereto.

The encryption information inserter 113 inserts encryption information related to encrypting performed by the encryptor 112 into a voice bitstream to generate an encrypted voice bitstream. The encrypted voice bitstream generated by the encryption information inserter 113 may be provided to the stream generator 114. The encryption information may be included in an auxiliary area of a bitstream. According to another exemplary embodiment, the encryption information may be included in another area of the bitstream, e.g., an area that has a little effect on a quality of a recovery signal. The encryption information may include an encryption key. If the encryption key is divided and inserted into the bitstream, division information of the encryption key may be further included. The encryption information may further include an encryption flag indicating whether the bitstream is encrypted. The encryption flag may use a particular synchronous bit. The encryption flag may be inserted into a start position of an area that is encrypted. The encryption information may further include position information of an encrypted area. The position information may include a start position and an end position of the encrypted area. Also, a particular synchronous bit may be inserted into the start position and the end position of the encoded area. If transmitter and receiver terminal devices pre-recognize that encrypting starts through setting of a security mode, an additional encryption flag may not be needed or included. If the transmitter and receiver terminal devices pre-recognize that the preset number of frames are selectively encrypted or a preset area is encrypted after the encryption flag is detected, additional position information may not be needed or included. The encryption information may be included in an area of the bitstream, e.g., may be included in an auxiliary area, or may be distributed and inserted into a plurality of areas.

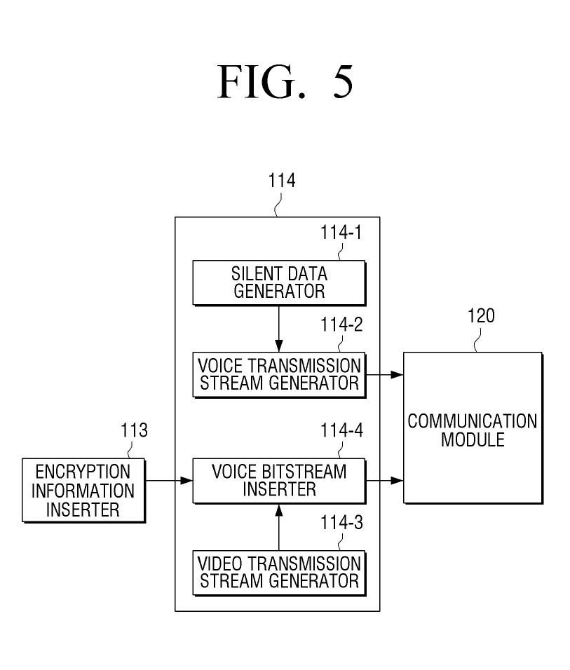

The stream generator 114 generates a voice transmission stream and a video transmission stream when performing a communication in the security mode. In particular, the stream generator 114 may insert an encrypted voice bitstream into the video transmission stream. The stream generator 114 will now be described in more detail with reference to FIG. 5. As shown in FIG. 5, the stream generator 114 may include a silent data generator 114-1, a voice transmission stream generator 114-2, a video transmission stream generator 114-3, and a voice bitstream inserter 114-4. The silent data generator 114-1 generates silent data that is to be inserted into the voice transmission stream. The voice transmission stream generator 114-2 may generate the voice transmission stream by using the silent data generated by the silent data generator 114-1 and provide the voice transmission stream to the communication module 120. The video transmission stream generator 114-3 may generate the video transmission stream, and the voice bitstream inserter 114-4 may insert an encrypted voice bitstream into the video transmission stream and provide the communication module 120 with the video transmission stream into which the encrypted voice bitstream is inserted. The voice bitstream inserter 114-4 may add and transmit indexing information indicating that the encrypted voice bitstream is included in the video transmission stream.

Here, the stream generator 114 may transmit the voice transmission stream and the video transmission stream to the communication module 120, though it is understood that this is only an exemplary embodiment. The stream generator 114 may multiplex (mux) the voice transmission stream and the video transmission stream to transmit an integrated stream to the communication module 120.

Referring to FIG. 3 again, the voice bitstream extractor 115 may extract an encrypted voice bitstream from a video transmission stream provided from the communication module 120. Here, the voice bitstream extractor 115 may extract the encrypted voice bitstream by using the indexing information or information included in the header area 410.

The encryption information extractor 116 extracts the encryption information from the encrypted voice bitstream extracted by the voice bitstream extractor 115.

The deciphering unit 117 deciphers or decrypts the encrypted voice bit stream by using the encryption information extracted by the encryption information extractor 116. Here, the deciphering unit 117 may perform the deciphering by using an encryption key included in the encryption information. The deciphering unit 117 may operate according to the same encryption algorithm as that used by the encryptor 112.

The decoder 118 may decode the bitstream deciphered by the deciphering unit 117. The decoder 118 may operate according to the same codec algorithm as that used by the encoder 111.

Encrypted voice data may be transmitted and received by using the security module 110 as described above without changing or updating a communication modem included in a user terminal device. Also, encryption information may be prevented from being lost due to transcoding in various communication environments.

A voice bitstream is encrypted after being encoded in the above-described exemplary embodiment, but this is only an exemplary embodiment and it is understood that one or more other exemplary embodiments are not limited thereto. According to another exemplary embodiment, the voice bitstream may be encrypted in a preset operation of an encoding process. For example, the encoding may be performed in a linear estimation operation or a quantization operation. Here, encryption information may be inserted into the auxiliary area 430 of the voice bitstream, a reserved field of a header area, or a not-used field.

Also, the voice bitstream is decoded after being deciphered in the above-described exemplary embodiment, but this is only an exemplary embodiment and it is understood that one or more other exemplary embodiments are not limited thereto. According to another exemplary embodiment, the decoding and the deciphering of the voice bitstream may be simultaneously performed. For example, the decoding of the voice bitstream may be performed in a linear estimation decoding operation or a quantization operation of a decoding process.

In addition, the encryption information may be inserted into the voice bitstream and then transmitted in the above-described exemplary embodiment, but this is only an exemplary embodiment and it is understood that one or more other exemplary embodiments are not limited thereto. According to another exemplary embodiment, the encryption information may be transmitted via an additional packet or another transmission stream.

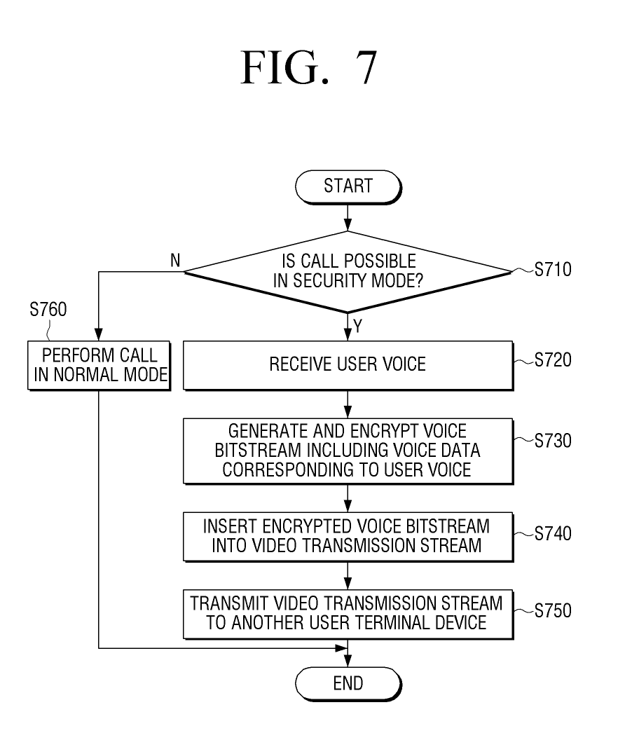

Secured communication methods according to various exemplary embodiments will now be described with reference to FIGS. 7 through 10.

FIG. 7 is a flowchart illustrating a secured communication method of a user terminal device of a transmitter, according to an exemplary embodiment.

In operation S710, the user terminal device 100 determines whether a call is possible in a security mode. Here, the user terminal device 100 may determine whether the call is possible in the security mode by using information of another user terminal device (i.e., a receiver user terminal device) that is received in a process of a communication connection to the other user terminal device.

If it is determined in operation S710 that the call is not possible or is not to be performed in the security mode, the user terminal device 100 performs the call with the other user terminal device in a normal mode (i.e., without encrypting the voice bitstream) in operation S760. If it is determined in operation S710 that the call is possible or is to be performed in the security mode, the user terminal device 100 receives or captures a user voice by using a microphone in operation S720.

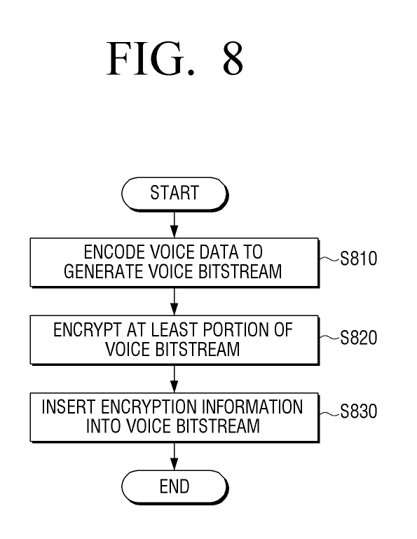

In operation S730, the user terminal device 100 generates and encrypts a voice bitstream including voice data corresponding to the user voice. A method of encrypting the voice bitstream according to an exemplary embodiment will now be described with reference to FIG. 8.

In operation S810, the user terminal device 100 encodes voice data to generate a voice bitstream. Here, the user terminal device 100 may encode the voice data by using a preset algorithm to generate the voice bitstream. For example, the user terminal device 100 may encode the voice data by using various types of codec algorithms such as a standard codec algorithm (e.g., MPEG-audio or the like recommended by ISO/IEC), a G series of standard codec algorithm (e.g., G.722 or the like recommended by ITU-T), an independent or proprietary codec algorithm, etc.

In operation S820, the user terminal device 100 encrypts at least a portion of the voice bitstream. Here, at least a portion of data included in a header area or a payload area of the voice bitstream may be encrypted or at least a portion of data of the header area and the payload area may be encrypted together. According to another exemplary embodiment, at least a portion of data included in an auxiliary area may be encrypted. The user terminal device 100 may also generate or provide encryption information (e.g., an encryption key) for the encrypting.

In operation S830, the user terminal device 100 inserts the encryption information into the voice bitstream. Here, the user terminal device 100 may insert the encryption information into at least an area of the voice bitstream (e.g., a part of the header area, the payload area, and the auxiliary area). The user terminal device 100 may encrypt the voice bitstream according to a method as described with reference to FIG. 8.

Referring to FIG. 7 again, the user terminal device 100 inserts the encrypted voice bitstream into a video transmission stream in operation 5740. Here, the user terminal device 100 may also insert silent data into a voice transmission stream. The user terminal device 100 may also include, in the video transmission stream (e.g., in the voice bitstream) indexing information indicating that the encrypted voice bitstream is inserted into the video transmission stream.

In operation S750, the user terminal device 100 transmits the video transmission stream to another user terminal device through a communication channel.

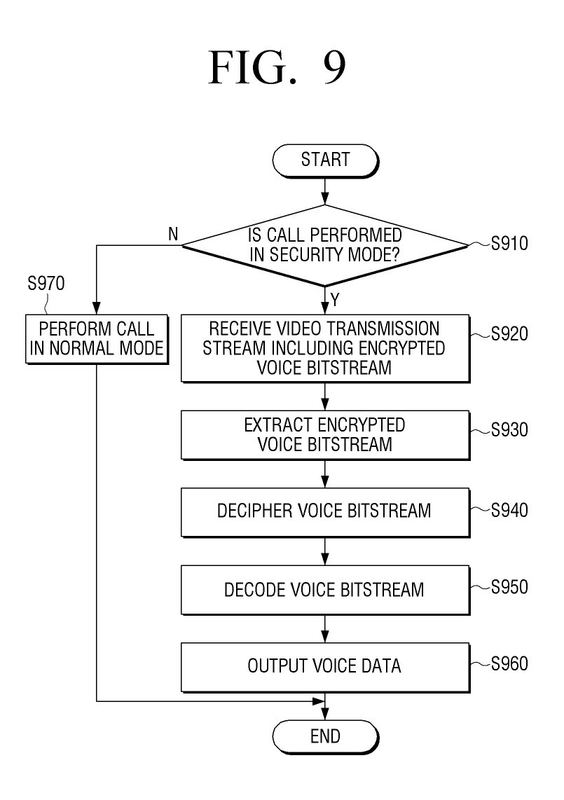

FIG. 9 is a flowchart illustrating a secured communication method of a user terminal device of a receiver, according to an exemplary embodiment.

In operation S910, the user terminal device 100 determines whether a call is to be performed in a security mode. Here, the user terminal device 100 may determine whether the call is possible in the security mode by using information of another user terminal device (i.e., a receiver user terminal device) that is received in a process of a communication connection to the other user terminal device.

If it is determined in operation S910 that the call is not to be performed in the security mode, the user terminal device 100 performs the call with the other user terminal device in a normal mode (i.e., without encrypting the voice bitstream) in operation S970. If it is determined in operation S910 that the call is to be performed in the security mode, the user terminal device 100 receives a video transmission stream including an encrypted voice bitstream in operation S920.

In operation S930, the user terminal device 100 extracts the encrypted voice bitstream from the video transmission stream. Here, the user terminal device 100 may extract the encrypted voice bitstream by using indexing information or information included in the video transmission stream, e.g., in a header area of the voice bitstream. The user terminal device 100 may output the encrypted voice bitstream extracted from the video transmission stream to a structure (e.g., a vocoder) for voice processing, as opposed to a structure for video processing.

In operation S940, the user terminal device 100 deciphers or decrypts the encrypted voice bitstream. Here, the user terminal device 100 may decipher the voice bitstream by using the same deciphering algorithm as the encryption algorithm.

The user terminal device 100 decodes the deciphered voice bitstream. Here, the user terminal device 100 may decode the voice bitstream by using the same codec algorithm as a codec algorithm used for encoding.

In operation S960, the user terminal device 100 outputs voice data. Here, although the user terminal device 100 performs a secured communication by using a flow (e.g., operational flow) of a video call, the user terminal device 100 may output the voice data by using the normal call output unit 151, as opposed to the video call output unit 153.

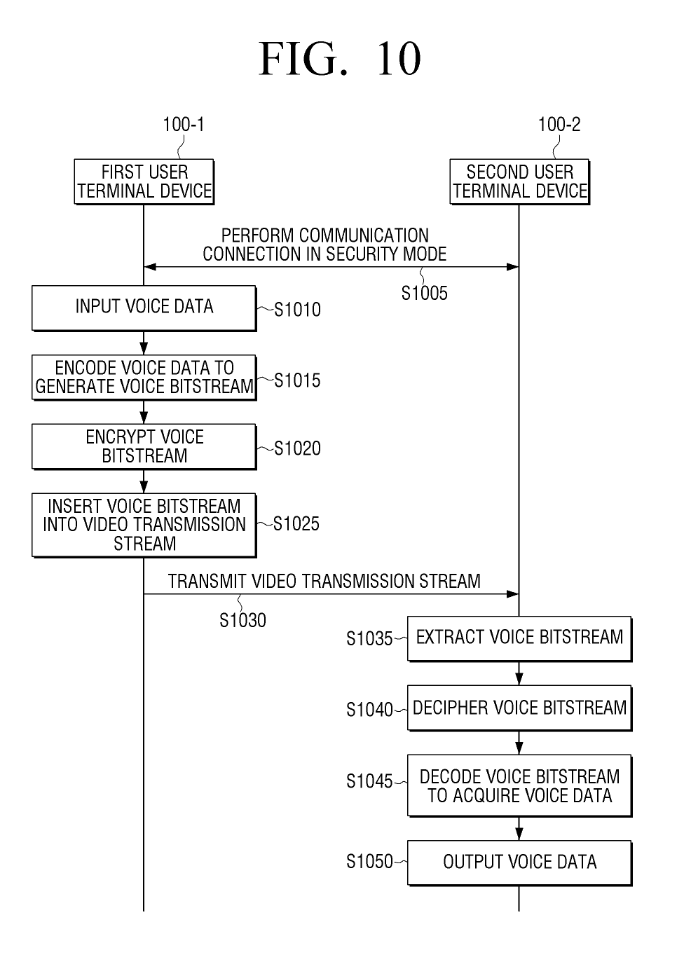

FIG. 10 is a sequence diagram illustrating a secured communication method according to an exemplary embodiment.

In operation S1005, the first user terminal device 100-1 and the second terminal device 100-2 perform a communication connection in a security mode. Here, the first user terminal device 100-1 and the second user terminal device 100-2 may check whether a call is possible in the security mode in the communication connection process and then perform the communication connection in the security mode accordingly.

In operation S1010, the first user terminal device 100-1 receives voice data. Here, the voice data may be input through a microphone, but this is only an exemplary embodiment and it is understood that one or more other exemplary embodiments are not limited thereto. For example, the voice data may be stored in a storage medium and then input.

In operation S1015, the first user terminal device 100-1 encodes the voice data to generate a voice bitstream.

In operation S1020, the first user terminal device 100-1 encrypts the voice bitstream. In detail, the first user terminal device 100-1 may encrypt at least a portion of data included in the generated voice bitstream, generate encryption information, and insert the encryption information to encrypt the voice bitstream.

In operation S1025, the first user terminal device 100-1 inserts the voice bitstream into a video transmission stream.

In operation S1030, the first user terminal device 100-1 transmits the video transmission stream to the second user terminal device 100-2.

In operation S1035, the second user terminal device 100-2 extracts the encrypted voice bitstream from the video transmission stream.

In operation S1040, the second user terminal device 100-2 deciphers or decrypts the encrypted voice bitstream. In detail, the second user terminal device 100-2 may extract the encryption information from the encrypted voice bitstream and decipher the voice bitstream by using the extracted encryption information.

In operation S1045, the second user terminal device 100-2 decodes the voice bitstream to acquire voice data.

In operation S1050, the second user terminal device 100-2 outputs the acquired voice data. Here, although a flow (e.g., operational flow) of a video call is used when performing a call in the security mode, the second user terminal device 100-2 may output the acquired voice data to the normal call output unit 151, as opposed to the video call output unit 153.

According to various exemplary embodiments as described above, encrypted voice data may be transmitted and received without changing or updating a communication modem included in a user terminal device. In various communication environments, encryption information may be prevented from being lost due to transcoding, and a secured communication for voice data may be provided between user terminal devices without updating a communication system.

In the above-described exemplary embodiments, if a vocoder included in the communication modem does not support a security mode, another structure (e.g., an application processor or the like) may encrypt a voice bitstream and insert the encrypted voice bitstream into a video transmission stream. However, this is only an exemplary embodiment and it is understood that one or more other exemplary embodiments are not limited thereto. If the vocoder included in the communication modem supports the security mode, the encrypted voice bitstream may be inserted into a voice transmission stream and then transmitted to another user terminal device.

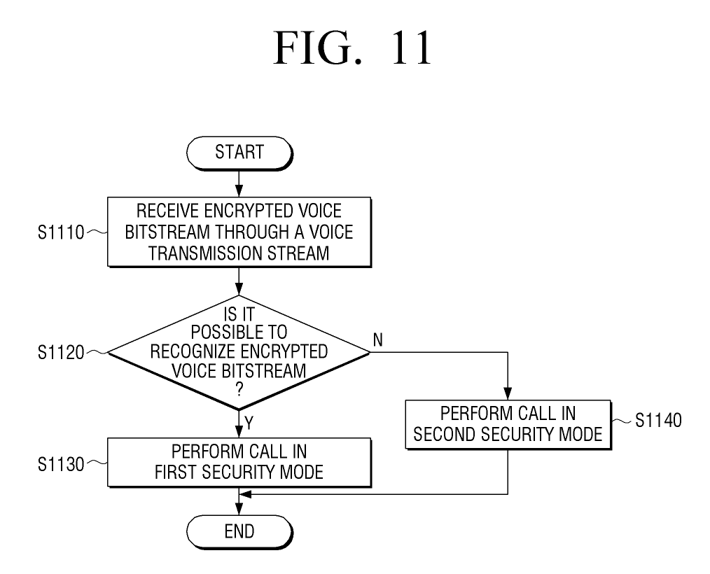

A secured communication method of a user terminal device according to another exemplary embodiment will now be described with reference to FIG. 11.

Referring to FIG. 11, in operation S1110, the first user terminal device 100-1 receives an encrypted voice bitstream from the second user terminal device 100-2, wherein the voice bitstream is encrypted through a voice transmission stream. Here, the voice transmission stream may include flag information indicating that the voice bitstream is encrypted.

In operation S1120, the first user terminal device 100-1 determines whether it is possible to recognize the encrypted voice bitstream. Here, if the flag information indicating that the voice bitstream is encrypted is recognized or transcoding is supported on a network to recognize the encrypted voice bitstream, the first user terminal device 100-1 may determine that it is possible to recognize the encrypted voice bitstream.

If it is determined in operation S1120 that it is possible to recognize the encrypted voice bitstream, the first user terminal device 100-1 makes a call to the second user terminal device 100-2 in a first security mode in operation S1130. If it is determined in operation S1120 that it is not possible to recognize the encrypted voice bitstream, the first user terminal device 100-1 makes a call to the second user terminal device 100-2 in a second security mode in operation S1140. Here, the first security mode refers to a security mode in which the encrypted voice bitstream is transmitted through the voice transmission stream, and the second security mode refers to a security mode in which the encrypted voice bitstream is transmitted through a video transmission stream.

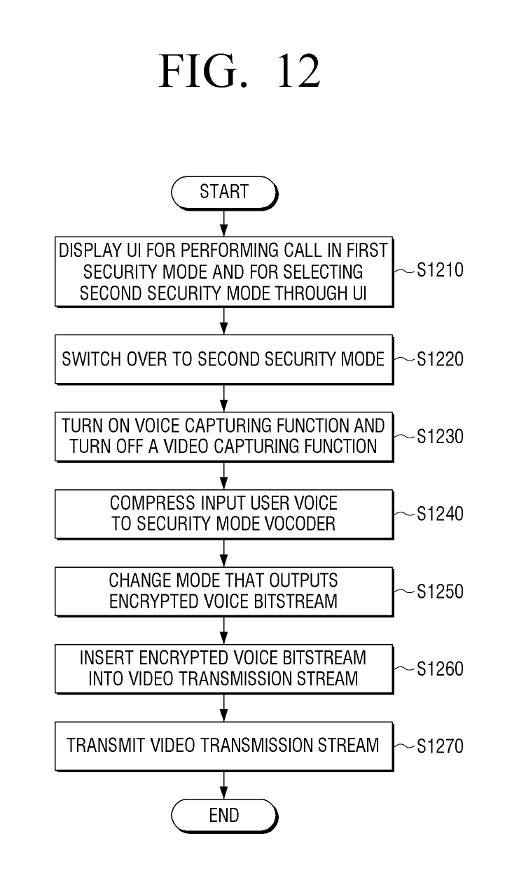

A method of making a call to the second user terminal device 100-2 in a second security mode as described in operation S1140 of FIG. 11 will now be described with reference to FIG. 12.

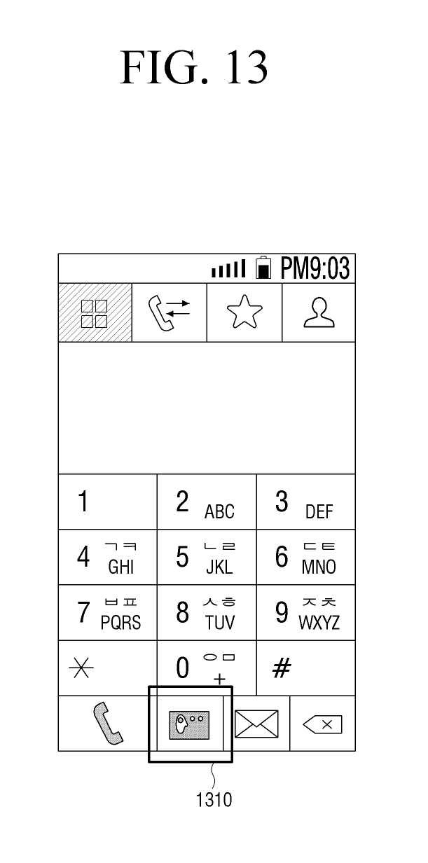

If it is determined in operation S1120 that it is not possible to recognize the encrypted voice bitstream inserted into the voice transmission stream received from the second user terminal 100-2, the first user terminal device 100-1 displays a user interface (UI) for making a call in a second security mode and receives a user command for selecting the second security mode through the UI in operation S1210. For example, the first user terminal device 100-1 may receive a user command that is to select an icon 1310 of a UI for performing a secured communication in the second security mode, as shown in FIG. 13. Here, the first user terminal device may display a UI including a message indicating that it is not possible to recognize the encrypted voice bitstream.

In operation S1220, the first user terminal device 100-1 switches over to the second security mode. Here, the second security mode refers to a mode in which the encrypted voice bitstream is inserted into the video transmission stream to make a secured call.

In operation S1230, the first user terminal device 100-1 turns on a voice capturing function and turns off a video capturing function. In other words, although the first user terminal device 100-1 uses the video transmission stream, a video not need be captured. Therefore, the first user terminal device 100-1 may turn off the camera module 130 to turn of the video capturing function.

In operation S1240, the first user terminal device 100-1 compresses an input user voice by using a security mode vocoder. This has been described in detail above with reference to FIG. 3, and thus repeated descriptions thereof are omitted below.

In operation S1250, the first user terminal device 100-1 changes a port that outputs the encrypted voice bitstream. In detail, the first user terminal device 100-1 may change the port outputting the encrypted voice bitstream from a voice port to a video port.

In operation S1260, the first user terminal device 100-1 inserts the encrypted voice bitstream into the video transmission stream.

In operation S1270, the first user terminal device 100-1 transmits the video transmission stream to the second user terminal device 100-2.

Accordingly, if the encrypted voice bitstream is not recognized due to a change of a system (e.g., a change of a network, a change from 3G to 4G, or the like), the encrypted voice bitstream is transmitted through the video transmission stream to continuously perform the secured communication regardless of the change of the system.

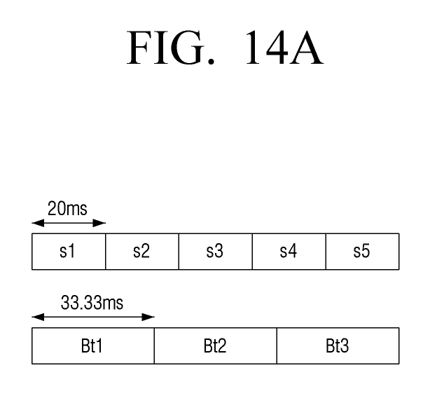

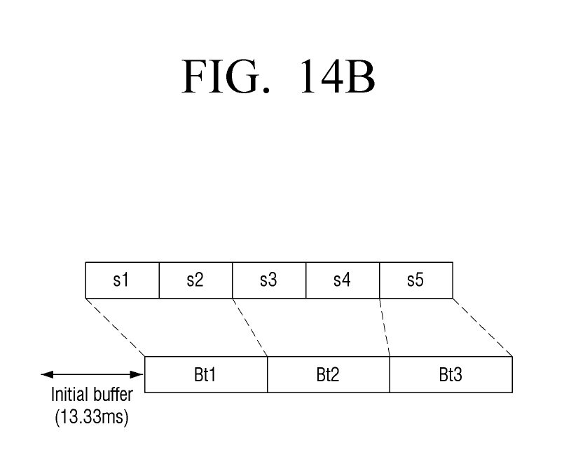

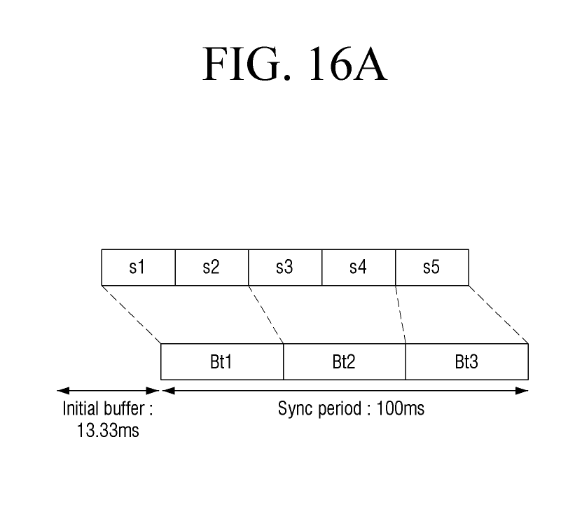

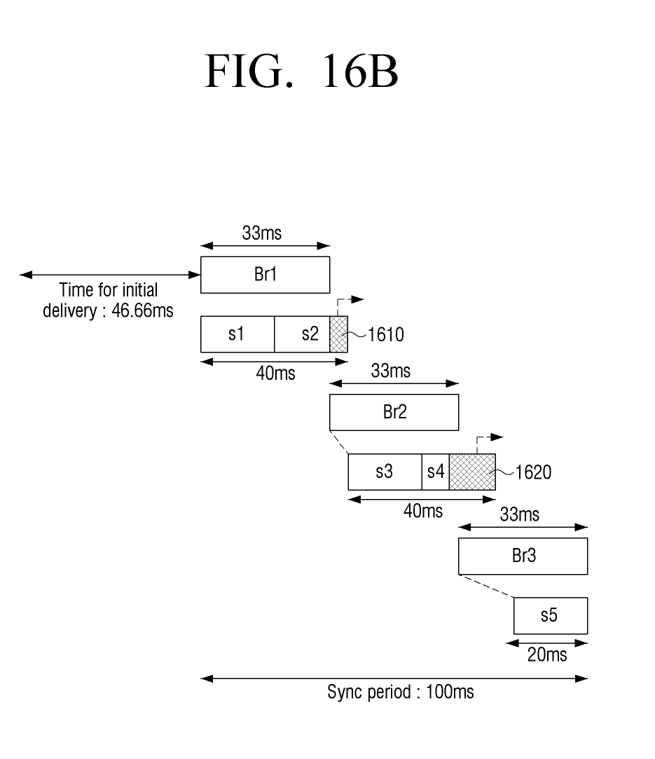

A method of transmitting a voice transmission stream and a video transmission stream will now be described with reference to FIGS. 14A and 14B, 15A and 15B, and 16A and 16B.

In general, as shown in FIG. 14A, the user terminal device 100 may transmit five voice transmission streams s1 through s5 and three video transmission streams Bt1 through Bt3 for 100 ms. However, according to an exemplary embodiment, as shown in FIG. 14B, the user terminal device 100 may set a buffering interval for a preset time (e.g., for 13.33 ms) to delay and transmit a video transmission stream by a preset time relative to the voice transmission stream.

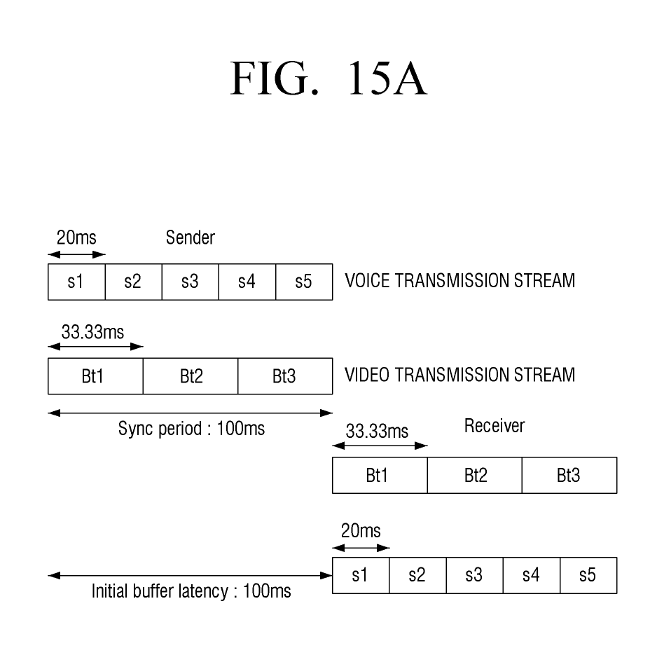

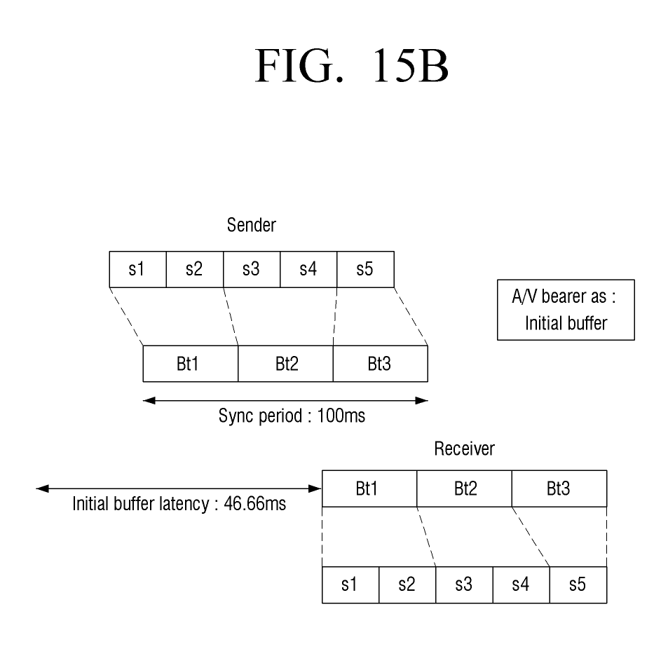

In detail, as shown in FIG. 15A, if a user terminal device of a transmitter transmits a voice transmission stream and a video transmission stream, a user terminal device of a receiver may set an initial buffering interval to 100 ms to synchronize the voice transmission stream and the video transmission stream.

However, according to an exemplary embodiment, as shown in FIG. 15B, if the user terminal device of the transmitter delays and transmits the video transmission stream after the voice transmission stream by a preset time (e.g., by 13.33 ms), the user terminal device of the receiver may set the buffering interval to 46.66 ms shorter than 100 ms to synchronize the voice transmission stream and the video transmission stream.

In other words, as described above, the user terminal device of the transmitter may delay and transmit the video transmission stream after the voice transmission stream by a preset time. Therefore, the user terminal device of the receiver may reduce the initial buffering interval for synchronizing the voice transmission stream and the video transmission stream.

In more detail, the user terminal device of the transmitter may delay and transmit the video transmission stream after the voice transmission stream by 13.33 ms. Here, voice transmission streams of s1 and s2 synchronize with a video transmission stream of Bt1, voice transmission streams of s3 and s4 synchronize with a video transmission stream of Bt2, and a voice transmission stream of s5 synchronizes with a video transmission stream of Bt3.

Also, the user terminal device of the receiver may delay and receive the video transmission stream and the voice transmission stream by 46.66 ms to synchronize the video transmission stream with the voice transmission stream. Here, when video transmission stream Br1 is received, a portion (i.e., a portion of 6.66 ms) of the voice transmission stream of s2 may remain. When video transmission stream Br2 is received, a portion (e.g., a portion of 13.33 ms) of the voice transmission stream of s4 may remain. However, when video transmission stream Br3 is received, a whole portion of the voice transmission stream of s5 may be received. In other words, the user terminal device of the transmitter may delay and transmit the voice transmission stream and the video transmission stream for 13.33, and thus the user terminal device of the receiver may have a minimum initial buffering interval 46.66 ms.

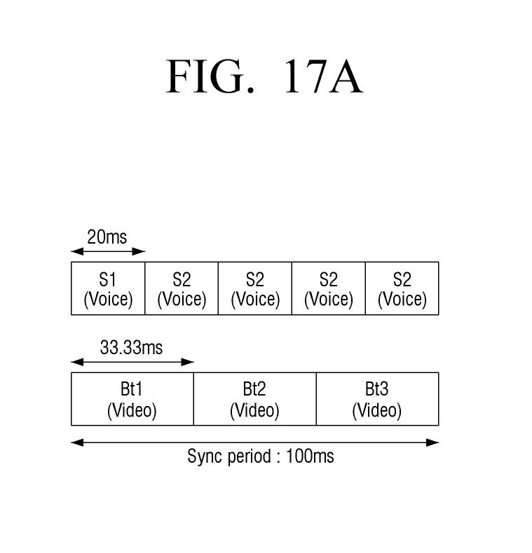

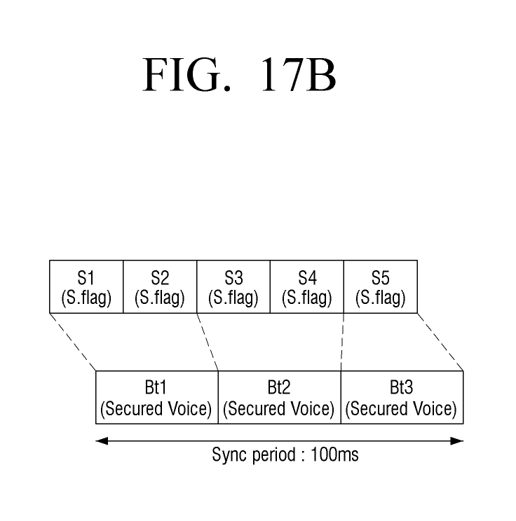

FIG. 17A is a view illustrating data that is inserted into a voice transmission stream and a video transmission stream when making a normal call, according to an exemplary embodiment. As shown in FIG. 17A, when making the normal call, a voice bitstream may be inserted into the voice transmission stream, and a video bitstream may be inserted into the video transmission stream. In other words, when making the normal call, flag information indicating that the voice bitstream is encrypted is not included.

FIG. 17B is a view illustrating data that is inserted into a voice transmission stream and a video transmission stream when making a call in a second security mode, according to an exemplary embodiment. As shown in FIG. 17B, flag information indicating that a voice bitstream is encrypted and/or included in the video transmission stream may be inserted into the voice transmission stream, and the encrypted voice bitstream may be inserted into the video transmission stream. In other words, a receiver terminal device may sense, detect, or obtain the flag information inserted into the voice transmission stream to perform a communication with another user terminal device in the second security mode.

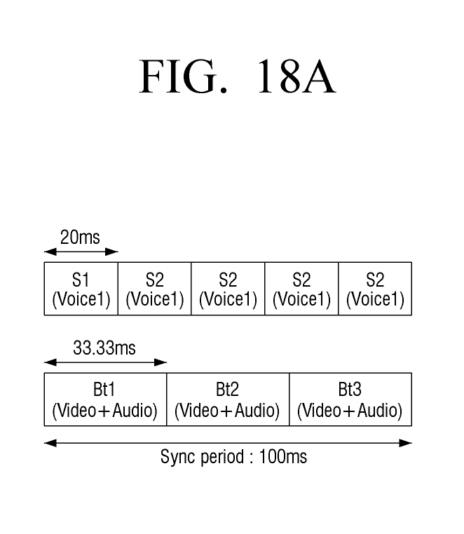

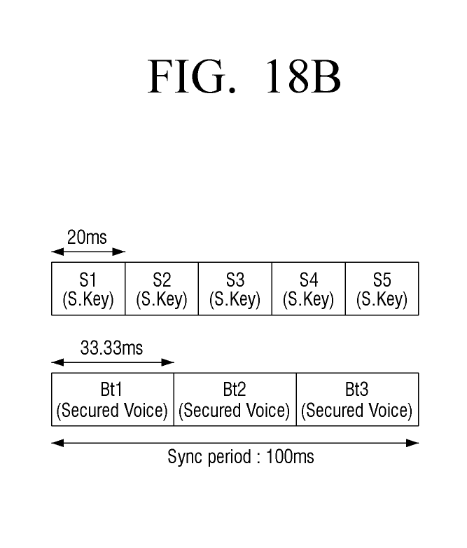

FIG. 18A is a view illustrating a method of inserting high-quality audio data into a video transmission stream to transmit the high-quality audio data, according to another exemplary embodiment. As shown in FIG. 18A, a voice bitstream may be inserted into a voice transmission stream, and a video bitstream and an audio bitstream may be inserted into a video transmission stream. In other words, as in a related art method, a user voice may be transmitted by using the voice transmission stream, and video data and high-quality audio data (e.g., background music or the like) may be transmitted together by using the video transmission stream to enable a high-quality call service.

FIG. 18B is a view illustrating a method of inserting control information into a voice transmission stream to transmit the control information, according to another exemplary embodiment. As shown in FIG. 18B, control information (e.g., encryption information) of an encrypted voice bitstream may be inserted into a voice transmission stream (alone or in addition to other data, such as silent data), and an encrypted voice bitstream may be inserted into a video transmission stream. In other words, when making a call in a second security mode, various types of information may be inserted into an empty video transmission stream to be transmitted. However, it is understood that, according to another exemplary embodiment, the encryption information may be included in the video transmission stream (e.g., in the voice bitstream). In this case, silent data or null data may be included in the voice transmission stream.

A device according to exemplary embodiments may include UI devices such as a processor, a memory that stores and executes program data, a permanent storage such as a disc drive, a communication port that communicates with an external device, a touch panel, keys, buttons, etc. Methods that are realized as software modules or algorithms may be stored as computer-readable codes or program commands executable on the processor on a computer-readable recording medium. Here, examples of the computer-readable recording medium include a magnetic storage medium (e.g., a read only memory (ROM), a random access memory (RAM), a floppy disc, a hard disc, or the like) and an optical reading medium (e.g. a CD-ROM, a digital versatile disc (DVD), or the like), etc. The computer-readable recording medium may store and execute a computer-readable code that is distributed onto computer systems that are connected to one another through a network to be read by a computer in a distribution fashion. A medium may be read by a computer, stored on a memory, and executed by a processor.

Exemplary embodiments may be embodied as functional block structures and various processing operations. The functional blocks may be embodied as the various numbers of software and/or software structures that execute particular functions. For example, exemplary embodiments may use integrated circuit (IC) structures such as a memory that executes various functions under control of one or more microprocessors or through other types of control devices, processing, a logic, a look-up table, etc. Like elements may be executed as software programming or software elements, exemplary embodiments may include various types of algorithms that are realized with combinations of data structures, processes, routines, and other programming structures to be embodied as a programming or scripting language such as C, C++, Java, assembler, or the like. Functional sides may be embodied as an algorithm that is executed by one or more processors. Exemplary embodiments may use existing technologies for electronic environment setting, signal processing, and/or data processing, etc. Terms such as “mechanism”, “element”, “means”, and “structure” may be widely used and are not limited to mechanical and physical structures. The terms may be linked to a processor, etc. to include a meaning of a series of routines of software.

Particular executions that are described in exemplary embodiments are exemplary and do not limit a technical range. For convenience of the specification, descriptions of existing electronic structures, control systems, software, and other functional sides of the systems may be omitted. Also, linkages of lines between elements illustrated in the drawings or connection members exemplarily indicate functional connections and/or physical or circuit connections. Therefore, in an actual device, the linkages of the lines or the connection members may indicate replaceable or additional various functional connections, physical connections, or circuit connections.

The term “the” used in the specification (in particular, in claims) or a similar indicating term may correspond to the singular or the plural. Also, if a range is described, the range includes individual values (if there is no description on the contrary). Therefore, the individual values of the range are effectively described in the detailed description. Orders of operations of a method may be clearly described or if there is no description, the operations may be performed in appropriate orders. However, the orders of the operations are not limited thereto. Use of all examples or exemplary terms (e.g., etc.) is to simply describe a technical concept, and thus the scope of claims is not limited by the examples or the exemplary terms without being limited by claims.

The foregoing exemplary embodiments and advantages are merely exemplary and are not to be construed as limiting. The present teaching can be readily applied to other types of apparatuses. Also, the description of exemplary embodiments is intended to be illustrative, and not to limit the scope of the claims, and many alternatives, modifications, and variations will be apparent to those skilled in the art.

What is claimed is:

1. A method of performing a secured communication by a user terminal device, the method comprising:
encrypting a first voice bitstream comprising voice data corresponding to a user voice for a call in a security mode between the user terminal device and another user terminal device;
inserting the encrypted first voice bitstream into a first video transmission stream; and
transmitting the first video transmission stream, into which the encrypted first voice bitstream is inserted, to the other user terminal device.

2. The method of claim 1, wherein the encrypting the first voice bitstream comprises:
encoding the voice data corresponding to the user voice to generate the first voice bitstream;
encrypting at least a portion of data of the first voice bitstream; and
inserting, into the first voice bitstream, encryption information used for the encrypting.

3. The method of claim 2, wherein the first voice bitstream comprises:
a header area comprising information indicating that the voice data is comprised in the first voice bitstream; and
a payload area comprising the encoded voice data.

4. The method of claim 3, wherein the encrypting the at least the portion of the data comprises encrypting the payload area of the first voice bitstream.

5. The method of claim 3, wherein:
the first voice bitstream further comprises an auxiliary area; and
the encryption information is inserted into at least one of the header area, the payload area, and the auxiliary area of the first voice bitstream.

6. The method of claim 2, wherein the encryption information comprises at least one of an encryption key, a position of an encrypted area of the first voice bitstream, and an encryption algorithm type.

7. The method of claim 1, further comprising:
generating a voice transmission stream comprising silent data; and
transmitting the generated voice transmission stream to the other user terminal device.

8. The method of claim 1, further comprising:
generating a voice transmission stream comprising encryption information used for the encrypting; and
transmitting the generated voice transmission stream to the other user terminal device.

9. The method of claim 1, further comprising in response to receiving a second video transmission stream into which an encrypted second voice bitstream is inserted when performing a call in the security mode, processing the received second video transmission stream by using a security mode vocoder.

10. The method of claim 9, wherein the processing the received second video transmission stream comprises:
extracting the encrypted second voice bitstream from the received second video transmission stream;
obtaining, from the extracted second voice bitstream, encryption information for decrypting the encrypted second voice bitstream;
decrypting the encrypted second voice bitstream based on the obtained encryption information; and
decoding the decrypted second voice bitstream to output voice data.

11. The method of claim 10, further comprising, in response to the call being performed in the security mode, turning off a camera module and a video call output unit of the user terminal device, and outputting the voice data of the received second video transmission stream using a normal call output unit.

12. The method of claim 1, wherein for the call in the security mode, the voice data is processed by using an application processor distinct from a communication modem of the user terminal device for processing voice data for a call in a normal mode.

13. A user terminal device comprising:
a security module configured to encrypt a first voice bitstream comprising voice data corresponding to a user voice for a call in a security mode between the user terminal device and another user terminal device, and to insert the encrypted first voice bitstream into a first video transmission stream; and
a communication module configured to transmit the first video transmission stream, into which the encrypted first voice bitstream is inserted, to the other user terminal device.

14. The user terminal device of claim 13, wherein the security module comprises:
an encoder configured to encode the voice data corresponding to the user voice to generate the first voice bitstream;
an encryptor configured to encrypt at least a portion of data of the first voice bitstream; and
an encryption information inserter configured to insert, into the first voice bitstream, encryption information used for the encrypting.

15. The user terminal device of claim 14, wherein the first voice bitstream comprises:
a header area comprising information indicating that the voice data is comprised in the first voice bitstream; and
a payload area comprising the encoded voice data.

16. The user terminal device of claim 15, wherein the encryptor is configured to encrypt the payload area of the first voice bitstream.

17. The user terminal device of claim 15, wherein:
the first voice bitstream further comprises an auxiliary area; and
the encryption information inserter is configured to insert the encryption information into at least one of the header area, the payload area, and the auxiliary area of the first voice bitstream.

18. The user terminal device of claim 14, wherein the encryption information comprises at least one of an encryption key, a position of an encrypted area of the first voice bitstream, and an encryption algorithm type.

19. The user terminal device of claim 13, wherein:
the security module further comprises a silent data generator configured to generate a voice transmission stream comprising silent data; and
the communication module is configured to transmit the generated voice transmission stream to the other user terminal device.

20. The user terminal device of claim 13, wherein the communication module is configured to transmit, to the other user terminal device, a voice transmission stream comprising encryption information used for the encrypting.
